(19) United States
(12) Patent Application Publication
(10) Pub. No.: US 2010/0263902 A1
(43) Pub. Date: Oct. 21, 2010

(54) Offset Slotting for Cable Trough Member

(75) Inventors: Jeffrey J. Jacobson, Shakopee, MN (US); Michael J. Nickel, Le Sueur, MN (US); Derek Sayres, Lonsdale, MN (US)

Correspondence Address: MERCHANT & GOULD PC, P.O. BOX 2903, MINNEAPOLIS, MN, 55402-0903, US

(73) Assignee: ADC TELECOMMUNICATIONS, INC., Eden Prairie, MN (US)

(21) Appl. No.: 12/763,262

(22) Filed: Apr. 20, 2010

Related U.S. Application Data
(60) Provisional application No. 61/170,857, filed on Apr. 20, 2009.

(51) Int. Cl. H02G 3/00

(52) U.S. Cl. 174/100

(57) ABSTRACT

Systems and methods for the management and routing of telecommunication cables include cable trough members. Generally, the trough members include a plurality of slots formed in the sidewalls of the trough members. These slots form a tortuous path as the slots extend along the sidewalls from a first end to a second open end at an end of the sidewalls.

### BACKGROUND

In the telecommunications industry, the use of optical fibers for signal transmissions is accelerating. With the increased utilization of optical fiber systems, optical fiber cable management requires industry attention.

One area of optical fiber management that is necessary is the routing of optical fibers from one piece of equipment to another. For example, in a telecommunications facility, optical fiber cables may be routed between fiber distribution equipment and optical line terminating equipment. In buildings and other structures that carry such equipment, the cable routing can take place in concealed ceiling areas or in any other manner to route cables from one location to another.

When routing optical fibers and other cables such as copper wires, it is desirable that a routing system will be readily modifiable and adaptable to changes in equipment needs. Accordingly, such routing systems include a plurality of components, such as trough members and couplers, for defining the cable routing paths. The trough members are joined together by couplers. U.S. Pat. Nos. 5,067,678; 5,316,243; and 5,752,781 teach cable routing systems that include a plurality of trough members and couplers.

Various concerns arise in the use of trough members. For example, it can be desirable to easily route cables into and out of the trough members. Further, the open ends can allow fiber to potentially escape from the trough members. Even if the trough members include covers to close the open ends, it may be necessary to periodically gain access to the interior portions of the trough members to, for example, add or remove fibers.

### SUMMARY

Embodiments of the present disclosure are directed to systems and methods for the management and routing of telecommunication cables and, more particularly, to cable trough members. Generally, the trough members include a plurality of slots formed in the sidewalls of the trough members. These slots form a tortuous path as the slots extend along the sidewalls from a first end to a second open end at an end of the sidewalls.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 is a side view of an embodiment of a trough member.

FIG. 2 is a side view of a portion of the trough member of FIG. 1.

FIG. 3 is a perspective view of the portion of the trough member of FIG. 2.

FIG. 4 is an end view of the trough member of FIG. 2.

FIG. 5 is a side view of a portion of another embodiment of a trough member.

FIG. 6 is a side view of a portion of another embodiment of a trough member.

### DETAILED DESCRIPTION

Embodiments of the present disclosure are directed to systems and methods for the management and routing of telecommunication cables and, more particularly, to cable trough members. Generally, the trough members include a plurality of slots formed in the sidewalls of the trough members. These slots form a tortuous path as the slots extend along the sidewalls from a first end to a second open end at an end of the sidewalls.

As used herein, the phrase “trough member” is used to refer to any trough, fitting, railway, raceway, or similarly configured component including any number of ends. In example embodiments, the trough members can be positioned to extend vertically or horizontally.

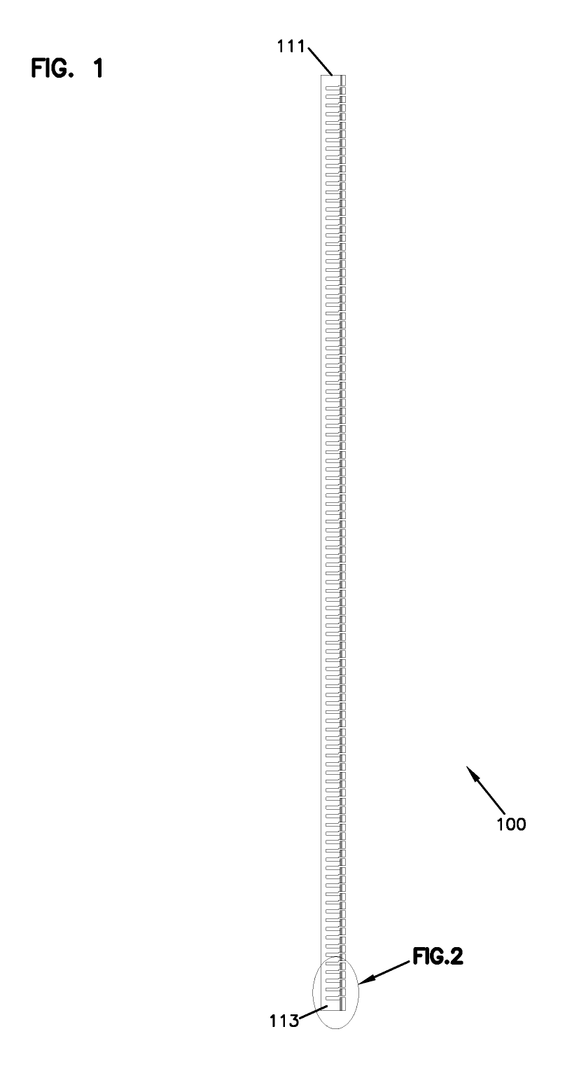

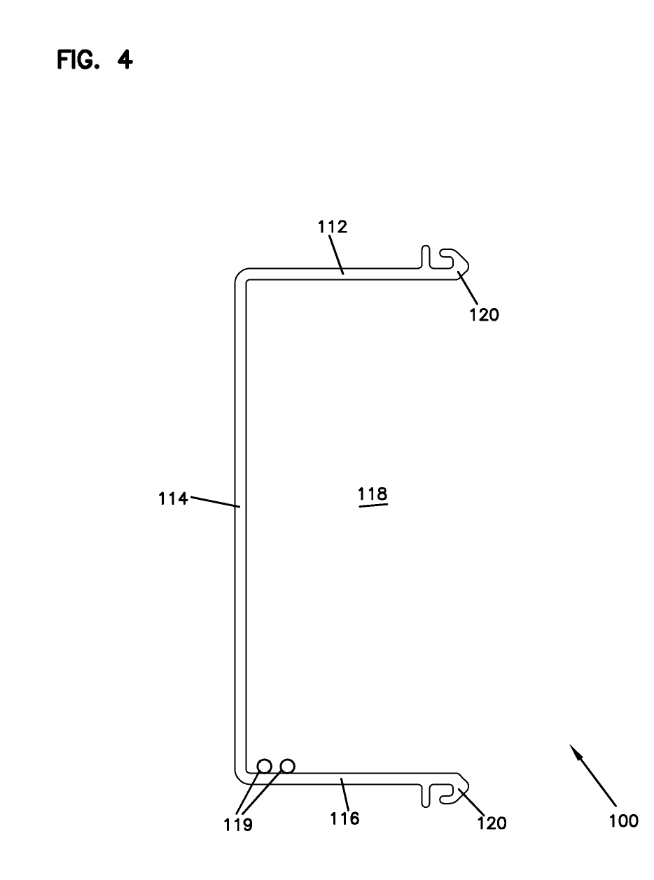

Referring now to FIGS. 1-4, an example embodiment of a trough member 100 is shown.

The example trough member 100 includes first and second sidewalls 112 and 116 coupled to a third wall 114 generally forming a U-shaped trough with an interior space 118 through which cables 119 such as fiber can be run.

The trough member 100 extends lengthwise in a vertical or horizontal direction when in use. The trough member 100 extends from a first end 111 to a second end 113. The trough member 100 can be of varying lengths and widths, and can be coupled to other trough members or similar structures to form a cable routing system.

Each of the free ends of the sidewalls 112, 116 includes a hinge portion 120. In example embodiments, the hinge portion 120 is used to allow a cover (not shown) to be coupled to the trough member 100. In one example, the cover can be coupled to the hinge portions 120 and can be moved between closed and open positions.

Addition details regarding one example cover that can be used with the trough member 100 is described in U.S. patent application Ser. No. 12/183,195 filed on Jul. 31, 2008, the entirety of which is hereby incorporated by reference. In other configurations, the hinge portion 120 and related cover are optional and need not be provided on the trough member.

In the example shown, the trough member 100 includes a plurality of slots 115 formed in the sidewalls 112, 116. The slots 115 are sized to allow cable to enter or exit the interior space 118 of the trough member 100 through the slots 115. In the examples shown, the slots 115 are formed at periodic intervals along the sidewalls 112, 116. Other configurations are possible.

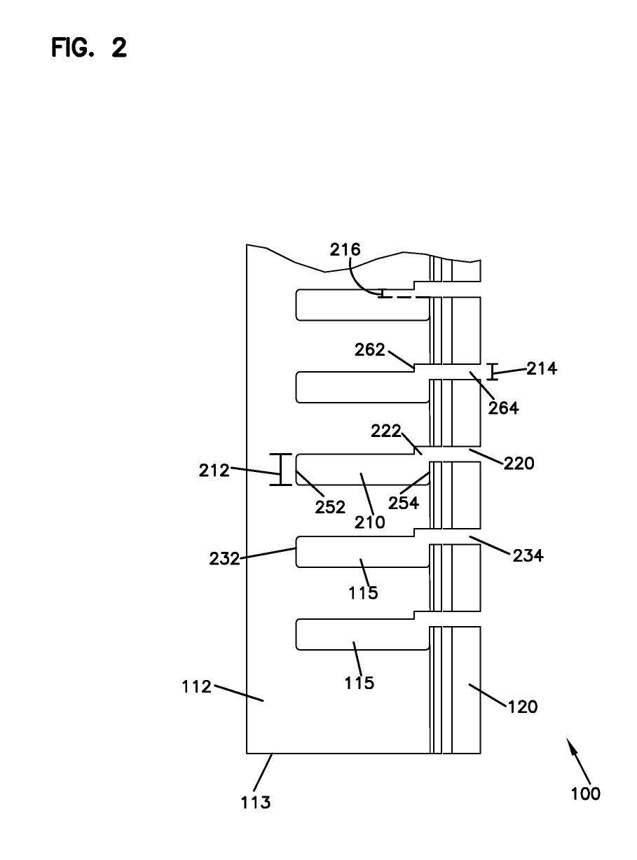

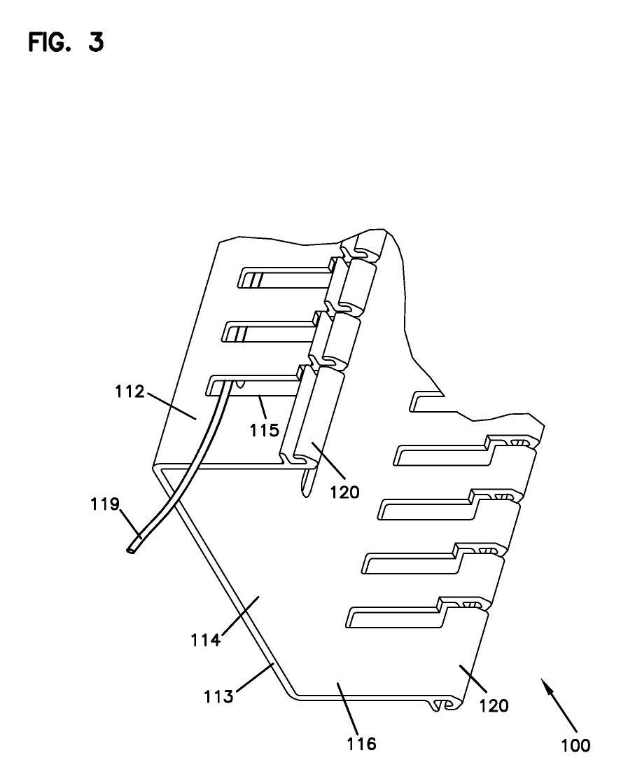

Referring now to FIGS. 2 and 3, in the example shown, each of the slots 115 extends from a first slot end 232 to a second slot end 234 that opens at the hinge portion 120.

Each slot 115 includes a first slot portion 210 and a second slot portion 220. The first slot portion 210 extends from a first end 252 to a second end 254. The second slot portion 220 extends from a first end 262 to a second end 264 that opens at the hinge portion 120. The second end 254 of the first slot portion 210 is joined to the first end 262 of the second slot portion 220 at a junction 222.

The second slot portion 220 is offset relative to the first slot portion 210 so that each slot 115 forms a tortuous path at the junction 222 as the slot 115 extend along the sidewalls 112, 116 from the first slot end 232 to the second slot end 234. The offset between the first and second slot portions 210, 220 is a partial offset, since the first and second slot portions 210, 220 partially overlap, as described further below.

This tortuous path formed at the junction 222 between the first and second slot portions 210, 220 of the slot 115 creates a weave or zigzag pattern because of the offset. When the cable 119 is placed in the slot 115, the cable must follow the tortuous path through the juncture 222 to slide out of the open second slot end 234 of the slot 115 that is open. The tortuous path helps to retain the fiber in the slot 115 of the trough member 100.

When the trough member 100 is used in a vertical orientation, the trough member 100 can be oriented so that the second slot portion 220 is positioned vertically above the first slot portion 210. See FIGS. 1-3. In this configuration, the tortuous path formed by the slots 115 requires cables to move upwards to move out of the slots 115.

In the example shown in FIGS. 1-4, a width 212 of the first slot portion 210 is 0.250 inches, and a width of the second slot portion 220 is 0.125 inches. In this example, the partial offset forms an overlap 216 of 0.063 inches. Other dimensions and configurations are possible, as described below.

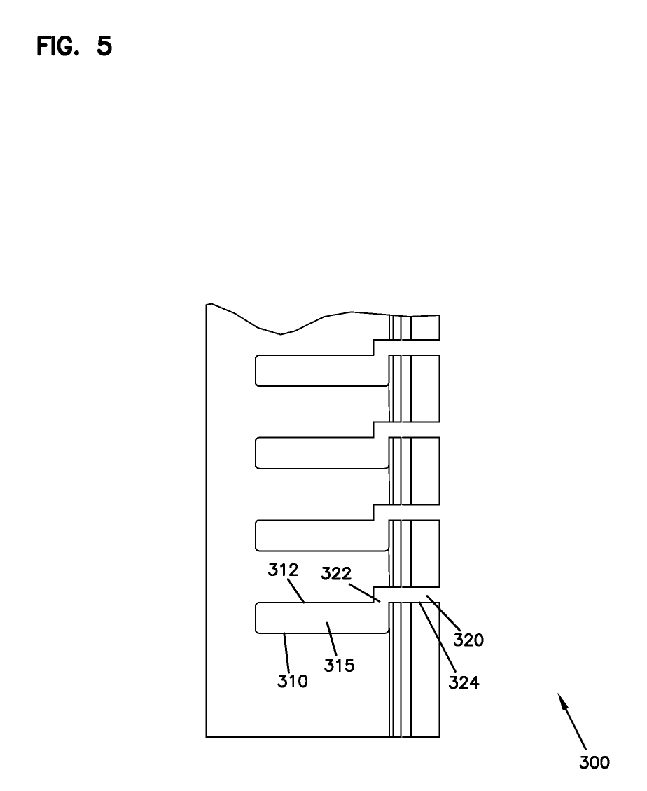

Referring now to FIG. 5, a portion of another example cable trough member 300 is shown. The trough member 300 is similar to the trough member 100 described above, except for the distinctions noted below.

The trough member 300 includes a plurality of slots 315, each having a first slot portion 310 and a second slot portion 320. In this example, the offset between the first and second slot portions 310, 320 is an aligned offset so that the first and second slot portions 310, 320 do not overlap. Instead, an edge 312 of the first slot portion 310 is aligned with an edge 312 of the second slot portion 320. In this configuration, a juncture 322 between the first and second slot portions 310, 320 forms a more tortuous path to further function to maintain cables in the slots 315.

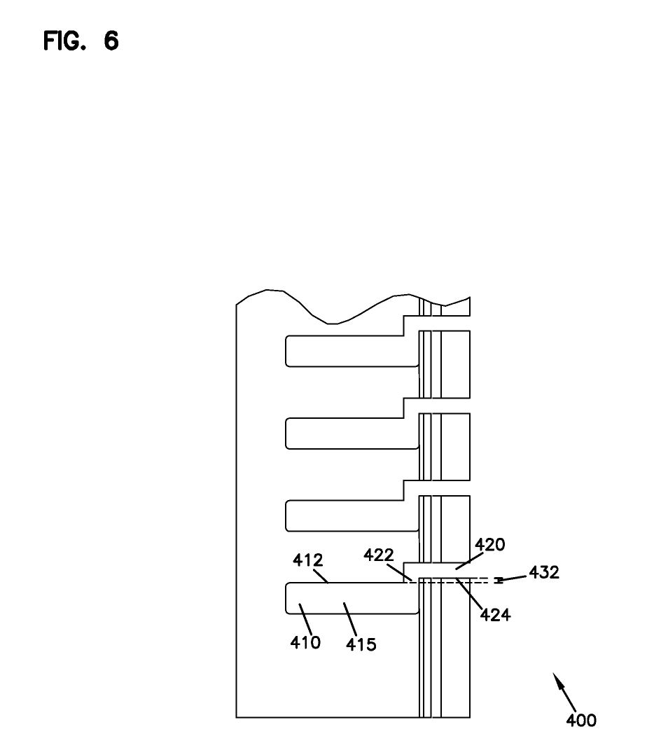

Referring now to FIG. 6, a portion of another example cable trough member 400 is shown. The trough member 400 is similar to the trough members 100, 300 described above, except for the distinctions noted below.

The trough member 400 includes a plurality of slots 415, each having a first slot portion 410 and a second slot portion 420. In this example, the offset between the first and second slot portions 410, 420 is a complete offset so that the first and second slot portions 310, 320 do not overlap. Instead, an edge 412 of the first slot portion 410 is offset a distance 432 of between 0.038-0.050 inches with respect to an edge 412 of the second slot portion 420. Other offset distances can be used. In this configuration, a juncture 422 between the first and second slot portions 310, 320 forms a more tortuous path to further function to maintain cables in the slots 415.

An example method of use of the trough members 100, 300, 400 is a follows. The trough members are incorporated into a portion of a cable routing system. Cables are routed through the trough members.

When it is desirable to route a cable from the interior of the trough member to the exterior of the trough member, the cable is routed through one of the slots formed in the trough member so that a portion of the cable is available on the exterior of the trough member. Conversely, when it is desirable to route a cable from exterior to the interior of the trough member, the cable is routed through one of the slots formed in the trough member so that a portion of the cable is positioned in the interior of the trough member. In either scenario, the tortuous path formed by the slots helps to keep the cable in place in the slots.

In example embodiments, the trough members 100, 300, 400 are extruded from a synthetic thermoplastic polymer such as an acrylonitrile-butadiene-styrene(ABS)/polycarbonate blend. Other manufacturing methods (e.g., molding) and materials can also be used.

When the trough members 100, 300, 400 are formed by extrusion, the slots 115, 315, 415 can be formed by punching and/or cutting the slots into the sidewalls of the trough members.

For example, in one embodiment, the first slot portions 210, 310, 410 are formed by punching the first slot portions into the sidewalls of the trough members at periodic intervals. The second slot portions 220, 320, 420 are formed by cutting the sidewalls of the trough members.

The various embodiments described above are provided by way of illustration only and should not be construed to limiting. Various modifications and changes that may be made to the embodiments described above without departing from the true spirit and scope of the disclosure.

What is claimed is:

1. A cable trough member of a cable routing system, the cable trough member comprising:
a base portion;
first and second sidewall portions extending from the base portion to form a trough shape; and
a plurality of slots formed along each of the first and second sidewalls, each of the slots including a first slot portion and a second slot portion, the first slot portion being offset from the second slot portion so that the slot forms a tortuous path as the slot extends from a first end to a second open end.

2. The cable trough member of claim 1, wherein the offset is a partial offset.

3. The cable trough member of claim 1, wherein the offset is an aligned offset.

4. The cable trough member of claim 1, wherein the offset is a complete offset.

5. The cable trough member of claim 1, wherein the cable trough member extends in a vertical orientation.

6. The cable trough member of claim 5, wherein the second slot portion is positioned vertically above the first slot portion.

7. The cable trough member of claim 5, wherein the second slot portion is offset vertically above the first slot portion.

8. The cable trough member of claim 5, wherein the first slot portion is connected to the second slot portion by a juncture that extends vertically.

9. The cable trough member of claim 8, wherein a cable that extends through the slot must be moved vertically through the juncture to be removed from the slot.

10. The cable trough member of claim 1, further comprising first and second portions of the first sidewall, the first and second portions forming the slot.

11. The cable trough member of claim 10, wherein each of the first and second sidewalls extends longitudinally relative to the trough member to offset the second slot portion from the first slot portion.

12. The cable trough member of claim 11, wherein the tortuous path formed by the offset is a weave or a zigzag pattern.

13. A cable trough member, comprising:
a base portion;
first and second sidewall portions extending from the base portion to form a trough shape extending longitudinally in a vertical orientation; and
a plurality of slots formed along at least one of the first and second sidewalls, each of the slots including a first slot portion, a second slot portion, and a juncture connecting the first and second slot portions, the first slot portion being offset vertically above the first slot portion so that the slot forms a tortuous path as the slot extends from a first end to a second open end.

14. The cable trough member of claim 13, wherein the offset is a partial offset.

15. The cable trough member of claim 13, wherein the offset is an aligned offset.

16. The cable trough member of claim 13, wherein the offset is a complete offset.

17. The cable trough member of claim 13, wherein the juncture extends vertically.

18. The cable trough member of claim 13, wherein a cable that extends through the slot must be moved vertically through the juncture to be removed from the slot.

19. The cable trough member of claim 13, further comprising first and second portions of the first sidewall, the first and second portions forming the slot.

20. The cable trough member of claim 13, wherein the tortuous path formed by the offset is a weave or a zigzag pattern.
